(19) United States
(12) Patent Application Publication
(10) Pub. No.: US 2013/0084511 A1
(43) Pub. Date: Apr. 4, 2013

(54) SOLID OXIDE FUEL CELL STACK

(71) Applicants: Duk-Hyoung Yoon, Yongin-si (KR); Sang-Jun Kong, Yongin-si (KR); Hyun Soh, Yongin-si (KR)

(72) Inventors: Duk-Hyoung Yoon, Yongin-si (KR); Sang-Jun Kong, Yongin-si (KR); Hyun Soh, Yongin-si (KR)

(73) Assignee: SAMSUNG SDI CO., LTD., Yongin-si (KR)

(21) Appl. No.: 13/551,195

(22) Filed: Jul. 17, 2012

(30) Foreign Application Priority Data
Oct. 4, 2011 (KR) 10-2011-0100630

(51) Int. Cl. H01M 8/04; H01M 8/24

(52) U.S. Cl. 429/428; 429/458

(57) ABSTRACT

A solid oxide fuel cell stack is disclosed. The solid oxide fuel cell stack may include a first fuel chamber, flow passage pipes, a unit cell, a second fuel chamber, a first oxidizer chamber, a second oxidizer chamber, and a stabilization chamber. The flow passage pipes are fluidly connected to a bottom end of the first fuel chamber. The unit cell, in which a bottom thereof is shielded, is formed to surround the flow passage pipes and forms the flow passage between the flow passage pipes and the unit cell. The second fuel chamber is fluidly connected to a top end of the unit cell and configured to discharge non-reaction gas from the unit cell. The stabilization chamber is formed between the second fuel chamber and the second oxidizer chamber.

### CROSS-REFERENCE TO RELATED APPLICATIONS

This application claims priority to and the benefit of Korean Patent Application No. 10-2011-0100630, filed on Oct. 4, 2011, in the Korean Intellectual Property Office, the entire content of which is incorporated herein by reference.

### BACKGROUND

1. Field

The present dislcosure relates to a solid oxide fuel cell stack, and particularly, to the solid oxide fuel cell stack capable of more stably sealing fuel.

2. Description of the Related Technology

Fuel cells may be classified depending on an electrolyte type. Fuel cells may have various output ranges and applications. A proper fuel cell may thus be selected depending on the purpose thereof. One type of fuel cell is a solid oxide fuel cell, which includes a fixed position and amount of the electrolyte. Not only is there little risk of electrolyte depletion, there is relatively little corrosion of the electrolyte, which lengthens material lifespan. These features have made solid oxide fuel cells more attractive for commercial and residential power generation.

Sealing of the chamber during introduction and discharge of the hydrogen-containing fuel in the cylindrical solid oxide fuel cell (SOFC) is important during operation of the fuel cell. When operating the SOFC, if the fuel containing a significant amount of hydrogen leaks into places other than the predetermined chambers, the risk of explosion increases due to abrupt oxidation caused by coupling with the high concentration of oxygen in the oxidizer. In addition, the sealing of the fuel in the SOFC has to withstand operating temperature of 800° C. These and other conditions make selection of materials and manufacturing SOFC's difficult.

### SUMMARY OF CERTAIN INVENTIVE ASPECTS

In a first aspect, a solid oxide fuel cell is provided, which is capable of reducing the risk of an oxidation and an explosion caused when the fuel and the oxidizer supplied for electrochemical reactions of the fuel cell are mixed due to aging of equipment.

In another aspect, a solid oxide fuel cell stack includes, for example, a first fuel chamber configured to supply fuel, flow passage pipes in fluid communication with a bottom end of the first fuel chamber, a unit cell having a shielded bottom end, the unit cell formed to surround the flow passage pipes and forming the flow passage between the flow passage pipes and the unit cell, a second fuel chamber in fluid communication with a top end of the unit cell and configured to discharge non-reaction gas from the unit cell, a first oxidizer chamber configured to introduce oxidizer, a second oxidizer chamber configured to allow the oxidizer from the first oxidizer chamber to be reduced in the outer peripheral surface of the unit cell and configured to discharge the reduced oxidizer, and a stabilization chamber formed between the second fuel chamber and the second oxidizer chamber and the stabilization chamber configured to receive inert gas.

In some embodiments, the inert gas is selected from the group consisting of helium, neon, argon, krypton, xenon, or radon. In some embodiments, the solid oxide fuel cell stack further includes a first separate plate. In some embodiments, the unit cell is positioned to penetrate the first separation plate. In some embodiments, the first separate plate is welded to an outer periphery surface of the unit cell. In some embodiments, the first separate plate is positioned to shield and spatially separate the stabilization chamber and the second fuel chamber. In some embodiments, a solid oxide fuel cell stack further includes a second separate plate. In some embodiments, the unit cell is configured to penetrate the second separate plate. In some embodiments, the second separate plate is welded to the outer periphery surface. In some embodiments, the second separate plate is configured to shield and spatially separate the stabilization chamber and the second oxidizer chamber.

In some embodiments, the solid oxide fuel cell stack further includes an inert gas supply portion configured to supply the inert gas to the stabilization chamber. In some embodiments, a solid oxide fuel cell stack further includes a pressure gauge configured to measure pressure of the inert gas within the stabilization chamber. In some embodiments, a solid oxide fuel cell stack further includes a controller configured to control the inert gas supply portion and maintain substantially constant pressure within the stabilization chamber. In some embodiments, the controller is configured to control the inert gas supply portion and to maintain pressure within the stabilization chamber above a minimum reference pressure higher than the gas pressure of the second fuel chamber and the oxidizer pressure of the second oxidizer chamber.

In some embodiments, the controller is configured to control the inert gas supply portion and to maintain substantially constant pressure of the stabilization chamber during operational pressure fluctuations in the stabilization chamber corresponding to the pressure change of the stabilization chamber. In some embodiments, a solid oxide fuel cell stack is further configured such that when the inert gas pressure within the stabilization chamber decreases, the amount of the inert gas supplied to the stabilization chamber increases up to a minimum reference pressure higher than the gas pressure of the second fuel chamber and the oxidizer pressure of the second oxidizer chamber by the controller. In some embodiments, a solid oxide fuel cell stack further includes a valve configured to open and close the inert gas discharge pipe, the inert gas discharge pipe configured to discharge the inert gas within the stabilization chamber. In some embodiments, the solid oxide fuel cell stack further includes a second controller configured to open the valve and the inert gas discharge pipe when the inert gas pressure within the stabilization chamber increases. In some embodiments, the solid oxide fuel cell stack further includes a distribution portion configured to uniformly supply the oxidizer from the first oxidizer chamber to the inside of the second oxidizer chamber.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a longitudinal section view schematically showing a shape of a fuel cell stack according to one embodiment of the disclosure.

FIG. 2 is a cross section view schematically showing a shape of a fuel cell stack of FIG. 1.

FIG. 3 is a partially enlarged view showing a part of another embodiment of a fuel cell stack.

FIG. 4 is a block view showing the shape of fuel cell modules according to another embodiment of the disclosure.

FIG. 5 is a flow chart showing driving processes of the fuel cell module according to another embodiment of the disclosure.

### DETAILED DESCRIPTION OF THE PREFERRED EMBODIMENT

### Detailed Description of Certain Inventive Embodiments

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, embodiments of the disclosure will be described with reference to the attached drawings. If there is no particular definition or mention, terms that indicate directions used to describe the disclosure are based on the state shown in the drawings. Further, the same reference numerals indicate the same members in the embodiments.

Fuel cells may include a fuel converter (a reformer and a reactor) configured to reform and supply the fuel, as well as the fuel cell modules. Here, the fuel cell modules assembly including one or more fuel cell stacks is configured to convert chemical energy into electrical energy and thermal energy by electro-chemical methods. That is, the fuel cell modules include the fuel cell stack and may include a pipe system through which fuel, oxides, cooling water, effluent and the like move. The fuel cell modules may also include a wiring through which electricity produced by the stack moves, a module controlling and monitoring the stack, and/or a module taking action when the stack is in an abnormal state. From among these, the present disclosure relates to the fuel cell stack configured to generate electrical energy through multiple electrochemical reactions within a plurality of unit cells as one unit. Hereinafter, further detail of fuel cell modules is provided.

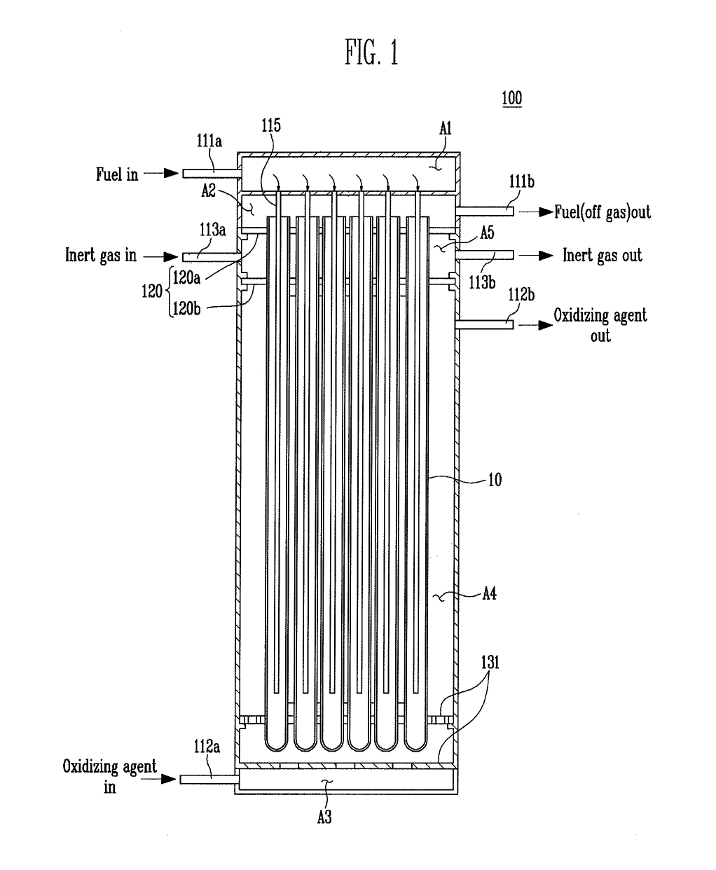

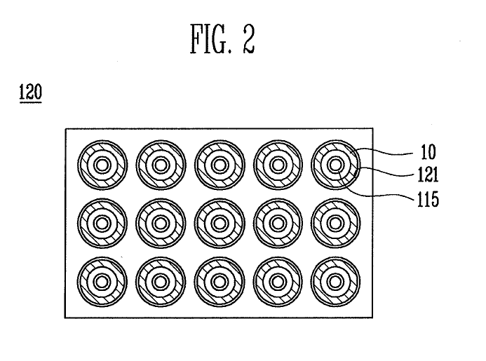

The unit cell 10 and flow passage pipes 115 will be described with reference to FIGS. 1 and 2. FIG. 1 is a longitudinal section view schematically showing a shape of the fuel cell stack according to an embodiment of the disclosure. FIG. 2 is a cross section view schematically showing a shape of the fuel cell stack of FIG. 1.

The unit cell 10 may be configured to receive the fuel reformed from the fuel converter (not shown) to become a configuration producing electricity by oxidation. The unit cell 10 may be formed as a tube type illustrated in FIGS. 1 and 2. The unit cell 10 may be an anode-supported type or a cathode-supported type dependent upon the intended purpose of the unit cell 10. The unit cell 10 of the present embodiment is the anode-supported type and the anode is formed in the inside thereof. However, this is for ease of description and experiment, and the disclosure is not limited to the anode-supported type. In the instant embodiment, the bottom end of the unit cell 10 is closed.

The flow passage pipes 115 are formed by a cylindrical member having a diameter smaller than an inside diameter of the unit cell 10. The flow passage pipes 115 are generally formed of steel configured to maintain durability even at the high temperature of 800° C. at which solid oxide fuel cell operates. The flow passage pipes 115 are disposed in a state inserted into the inside of the unit cell 10. Both ends of the flow passage pipes 115 are opened. The flow passage, in which gas and/or fluid may communicate, is formed to allow an interval between the flow passage pipe 115 and the unit cell 10 to be regularly maintained.

On the other hand, at this time, the top end of the flow passage pipes 115 are fluidly connected to a first fuel chamber A1 (to be described in more detail later), and the top end of the unit cell 10 is fluidly connected to a second fuel chamber A2 (to be described in more detail later). The first fuel chamber A1 and the second fuel chamber A2 are described with reference to FIGS. 1 and 2. As described above, the unit cell 10 receives the fuel making up hydrogen as main components and produces electrons by the oxidation. At this time, the first fuel chamber A1 is positioned at an uppermost end of the fuel cell stack 100, and means a space receiving the fuel from the fuel supply device such as the fuel converter through a fuel supply pipe 111a. The bottom end of the first fuel chamber A1 is fluidly connected to the flow passage pipes 115. The fuel supplied to the first fuel chamber A1 is distributed to each of the plurality of flow passage pipes 115 and flows through each of the plurality of flow passage pipes 115. The second fuel chamber A2 is formed to be configured with one floor under the first fuel chamber A1. The second fuel chamber A2 is fluidly connected to the top end of the unit cell 10, such that off gas may be introduced from the unit cell 10. The second fuel chamber A2 includes an off gas discharge pipe 111b discharging the introduced off gas.

That is, first, during operation of the fuel cell the fuel having hydrogen as the main component is introduced into the first fuel chamber A1 through the fuel supply pipe 111a, and then, is introduced into the top end of each of the flow passage pipes 115. The fuel introduced into each of the flow passage pipes 115 triggers the oxidation while flowing along the flow passage between the flow passage pipes 115 and an inner peripheral surface of the unit cell 10 from the bottom end of the flow passage pipe 115. The off gas, in which the oxidation terminates, is introduced from the top end of the unit cell 10 into the second fuel chamber A2, and then is discharged through the off gas discharge pipe 111b.

The first oxidizer chamber A3 and the second oxidizer chamber A4 are described with reference to FIGS. 1 and 2. The first oxidizer chamber A3 is positioned at the lowermost end of the fuel cell stack 100, and is the space into which the oxidizer from the outside of the fuel cell stack is first introduced through the oxidizer supply pipe during operation of the fuel cell. The top of the first oxidizer chamber A3 is provided with a distribution portion 131. The distribution portion 131 is formed by at least one plate formed with holes. The distribution portion 131 will be responsible for uniformly supplying the oxidizer to the second oxidizer chamber A4 to be described later.

The second oxidizer chamber A4 is the space surrounding the outside of the unit cell 10. The oxidizer passing through the distribution portion 131 is introduced into the second oxidizer chamber A4. The oxidizer triggers reduction at an outer peripheral surface of the unit cell 10, which is the cathode in the present embodiment, and generates oxygen ions, while rising from the bottom end of the second oxidizer chamber A4. During operation of the fuel cell, the oxidizer enters in the bottom of the fuel cell at an oxidizing agent in pipe 112a, then rises up to the top end of the second oxidizer chamber A4 and is discharged into the outside through the oxidizer discharge port 112b formed on a side.

On the other hand, the bottom end of the second fuel chamber A2 and the top end of the second oxidizer chamber A4 are shielded by a first separate plate 120a and a second separate plate 120b, respectively. The separate plate 120; 120a, 120b may be formed in a plate shape. For example, and as shown in FIG. 2, the separate plate 120; 120a, 120b includes holes 121 having the same number as the unit cell 10 configured to accommodate the unit cell 10. When manufacturing the fuel cell stack 100, after the unit cell 10 is inserted into the hole 121 of the separate plate 120, the second fuel chamber A2 and the second oxidizer chamber A4 formed by the separate plate 120 are shielded from each other by welding the hole 121 to the outer peripheral surface of the unit cell 10.

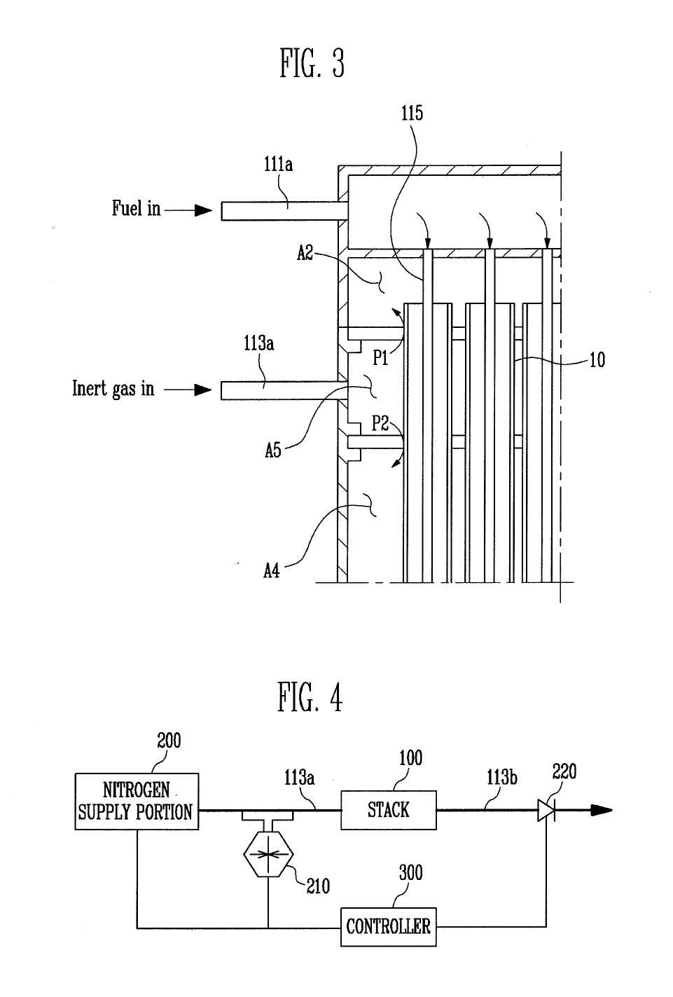

FIG. 3 is a partially enlarged view showing a part of the fuel cell stack of the disclosure. Hereinafter, in FIG. 3, a stabilization chamber A5 addressing the above problem in connection with FIG. 1 will be described. As illustrated in FIG. 1, the stabilization chamber A5 is formed in the space between the first separate plate 120a and the second separate plate 120b. As described earlier, the stabilization chamber A5 is shielded with the second fuel chamber A2 and the second oxidizer chamber A4, respectively, by the shielding structure of the separate plate 120. Further, the stabilization chamber A5 includes a inert gas supply pipe 113a introducing inert gas from a separate inert gas supply portion (not shown), and a inert gas discharge pipe 113b discharging the inert gas gaseous molecules into the outside. Here, the inert gas includes the inert gas in the narrower sense, that is, elements such as helium, neon, argon, krypton, xenon, radon, and gaseous molecules such as nitrogen that have low chemical reactivity. However, nitrogen, which accounts for approximately 80% of air, has advantages economically. Hereinafter, for convenience in the present description, nitrogen is used as the exemplary inert gas.

At this time during operation of the fuel cell, it is preferable that the pressure of the stabilization chamber A5 becomes higher than the pressures of the second fuel chamber A2 and the second oxidizer chamber A4 (hereinafter, higher pressure of the pressures of the second fuel chamber A2 and the second oxidizer chamber A4 refers to the minimum reference pressure.). Cracks may occur in the first separate plate 120a, such that gas leaks between the second fuel chamber A2 and the stabilization chamber A5, or cracks may occur in the second separate plate 120b, such that the gas may leak between the oxidizer chamber A4 and the stabilization chamber A5. At this time, if the pressure of the stabilization chamber A5 is higher than the minimum reference pressure, as shown in FIG. 3, the pressure of the inert gas may be high, such that the nitrogen leaks into the second fuel chamber A2 or the second oxidizer chamber A4 in the first direction P1 or in the second direction P2. That is, the pressure of the stabilization chamber A5 is set to become higher than the minimum reference pressure, thereby preventing the fuel or the oxidizer from flowing in the stabilization chamber A5 and therefore, preventing the hydrogen and the oxygen contained in each of the fuel or the oxidizer, respectively, from contacting each other.

On the other hand, as described earlier, when the main component of the fuel in the unit cell 10, which is hydrogen, contacts the oxygen contained in the oxidizer, there may be unintentional oxidation or even an explosion. To remove such risks, the separate plate 120 may be doubly formed in an inside surface thereof without separate configuration supplying the inert gas to prevent the oxidizer of the second fuel chamber A2 and the second oxidizer chamber A4 from contacting each other.

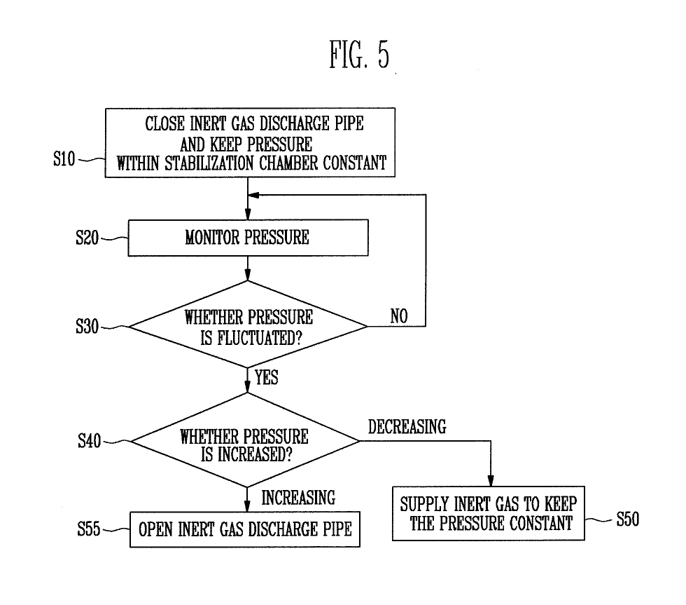

Another embodiment of the disclosure will be described with reference to FIGS. 4 and 5. FIG. 4 is a block view showing the shape of fuel cell modules according to another embodiment of the disclosure, and FIG. 5 is a flow chart showing driving processes of the fuel cell module according to the disclosure. On the other hand, in FIG. 4, description about the portions that are not directly related to the present embodiment such as device supplying the fuel and the oxidizer related to the driving of the fuel cell is omitted.

The present embodiment relates to a more specific method and configuration controlling the pressure of the inert gas during operation of the fuel cell. That is, the present embodiment is further provided with a pressure gauge 210, a valve 220 and a controller 300. The pressure gauge 210 is formed in the inert gas supply pipe 113a, which is fluidly connected to a nitrogen supply portion 200. The pressure gauge 210 may further be formed and configured to measure the pressure of the inert gas within the stabilization chamber A5. The valve 220 is formed in the inert gas discharge pipe 113b and is configured to open and close the inert gas discharge pipe 113b. First, the controller 300 may be configured to keep the pressure within the stabilization chamber AS constant above the minimum reference pressure in a state closing the inert gas discharge pipe 113b of the fuel cell stack 100 (S10).

Further, during operation of the fell cell, the pressure, within the stabilization chamber A5, transferred from the pressure gauge 210 is continually and periodically monitored (S20). When the pressure within the stabilization chamber AS is fluctuated (S30), first, it may be determined that cracks have formed in the sealing structure of the separate plate 120. In this case, the internal pressure of the stabilization chamber AS may be kept constant by simply supplying a more inert gas, but first, it is preferably determined that whether the pressure of the stabilization chamber AS has increased or decreased (S40). When the pressure of the stabilization chamber AS decreases, as described earlier, the inert gas is continually supplied so that the pressure of the stabilization chamber AS keeps constant above the minimum reference pressure in a state closing the valve 220 (S50). When the pressure of the stabilization chamber AS is increased, it may be determined that the fuel or the oxidizer is already introduced from the pressure of the second fuel chamber A2 or the second oxidizer chamber A4 to open the valve 220, thereby discharging the gases within the stabilization chamber A5 (S55). In this case, the oxidizer or the fuel introduced within the stabilization chamber A5 is continually discharged into the outside, thereby obtaining cooling effect sufficed to avoid an explosion.

In some embodiments of the fuel cell disclosed herein, if the shield structure of the chamber in which the fuel and the oxidizer are supplied deteriorates, abrupt oxidation or explosion may be prevented.

Further, in some embodiments of fuel cell disclosed herein, the fuel cell may be configured to cope with pressure changes due to a defect occurred during the operation of the fuel cell, thereby ensuring the soundness of the fuel cell equipment itself and extending the life of the fuel cell.

While this disclosure has been described in connection with certain exemplary embodiments, it will be appreciated by those skilled in the art that various modifications and changes may be made without departing from the scope of the present disclosure. It will also be appreciated by those of skill in the art that parts mixed with one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A solid oxide fuel cell stack, comprising:
a first fuel chamber configured to supply fuel;
flow passage pipes in fluid communication with a bottom end of the first fuel chamber;
a unit cell having a shielded bottom end, the unit cell formed to surround the flow passage pipes and forming the flow passage between the flow passage pipes and the unit cell;
a second fuel chamber in fluid communication with a top end of the unit cell and configured to discharge non-reaction gas from the unit cell;
a first oxidizer chamber configured to introduce oxidizer;
a second oxidizer chamber configured to allow the oxidizer from the first oxidizer chamber to reduce in the outer peripheral surface of the unit cell and configured to discharge the reduced oxidizer; and
a stabilization chamber formed between the second fuel chamber and the second oxidizer chamber and, the stabilization chamber further configured to receive inert gas.

2. The solid oxide fuel cell stack of claim 1, wherein the inert gas is selected from the group of helium, neon, argon, krypton, xenon, and radon.

3. The solid oxide fuel cell stack of claim 1 further comprising:
a first separate plate, wherein the unit cell is positioned so as to penetrate the first separation plate, wherein the first separate plate is welded to an outer periphery surface of the unit cell, and wherein the first separate plate is positioned to shield and spatially separate the stabilization chamber and the second fuel chamber; and
a second separate plate, wherein the unit cell is positioned penetrating the second separate plate, wherein the second separate plate is welded to the outer periphery surface, and wherein the second separate plate is positioned to shield and spatially separate the stabilization chamber and the second oxidizer chamber.

4. The solid oxide fuel cell stack of claim 1 further comprising an inert gas supply portion configured to supply the inert gas to the stabilization chamber.

5. The solid oxide fuel cell stack of claim 4 further comprising a pressure gauge configured to measure pressure of the inert gas within the stabilization chamber.

6. The solid oxide fuel cell stack of claim 5, further comprising a controller configured to control the inert gas supply portion and maintain substantially constant pressure within the stabilization chamber.

7. The solid oxide fuel cell stack of claim 5, wherein the controller is configured to control the inert gas supply portion and maintain pressure within the stabilization chamber above a minimum reference pressure higher than the gas pressure of the second fuel chamber and the oxidizer pressure of the second oxidizer chamber.

8. The solid oxide fuel cell stack of claim 5, wherein the controller is configured to control the inert gas supply portion and maintain substantially constant pressure of the stabilization chamber during operational presure fluctuations in the stabilization chamber in corresponding to the pressure change of the stabilization chamber.

9. The solid oxide fuel cell stack of claim 8 further configured such that when the inert gas pressure within the stabilization chamber decreases, the pressure of the inert gas supplied to the stabilization chamber increases up to a minimum reference pressure higher than the gas pressure of the second fuel chamber and the oxidizer pressure of the second oxidizer chamber by the controller.

10. The solid oxide fuel cell stack of claim 5 further comprising a valve configured to open and close the inert gas discharge pipe, the inert gas discharge pipe configured to discharge the inert gas within the stabilization chamber; and a second controller configured to open the valve and the inert gas discharge pipe when the inert gas pressure within the stabilization chamber increases.

11. The solid oxide fuel cell stack of claim 1 further comprising a distribution portion configured to uniformly supply the oxidizer from the first oxidizer chamber to the inside of the second oxidizer chamber.
